(19) United States
(12) Patent Application Publication
(10) Pub. No.: US 2020/0385023 A1
(43) Pub. Date: Dec. 10, 2020

(54) VEHICLE CONTROL APPARATUS, VEHICLE, OPERATION METHOD OF VEHICLE CONTROL APPARATUS, AND NON-TRANSITORY COMPUTER-READABLE STORAGE MEDIUM

(71) Applicant: HONDA MOTOR CO., LTD., Tokyo (JP)

(72) Inventor: Atsuhiro EGUCHI, Wako-shi (JP)

(21) Appl. No.: 16/890,272

(22) Filed: Jun. 2, 2020

(30) Foreign Application Priority Data
Jun. 6, 2019 (JP) 2019-106479

(51) Int. Cl. B60W 60/00; B60W 30/18

(52) U.S. Cl. CPC B60W 60/0025; B60W 2552/50; B60W 2552/53; B60W 30/18163

(57) ABSTRACT

A vehicle control apparatus that controls a vehicle, comprising: a division line detector configured to detect a division line of a road; a road boundary detector configured to detect a road boundary of the road; and a controller configured to execute first lane departure suppression control to suppress the departure of the vehicle from the division line and second lane departure suppression control to suppress the departure of the vehicle from the road boundary, wherein the controller executes the first lane departure suppression control in accordance with a distance in a lateral direction from the vehicle to a predetermined position based on the division line, and executes the second lane departure suppression control based on a time until the vehicle arrives at a predetermined position based on the road boundary.

### CROSS-REFERENCE TO RELATED APPLICATION(S)

This application claims priority to and the benefit of Japanese Patent Application No. 2019-106479 filed on Jun. 6, 2019, the entire disclosure of which is incorporated herein by reference.

### BACKGROUND OF THE INVENTION

### Field of the Invention

The present invention relates to a vehicle control apparatus, a vehicle, an operation method of the vehicle control apparatus, and a non-transitory computer-readable storage medium.

### Description of the Related Art

Conventionally, there is known a lane departure prevention technique as an example of support for an occupant of a vehicle. Japanese Patent Laid-Open No. 2008-257681 discloses that a vehicle determines whether the self-vehicle has departed from a lane by predicting a lane departure time based on a lane distance and vehicle speed.

However, the technique disclosed in Japanese Patent Laid-Open No. 2008-257681 is problematic in that it is difficult to execute appropriate vehicle control with respect to each of a road boundary and a division line.

The present invention provides a technique that implements appropriate vehicle control with respect to each of a road boundary and a division line.

### SUMMARY OF THE INVENTION

According to one aspect of the present invention, there is provided a vehicle control apparatus that controls a vehicle, comprising: a division line detector configured to detect a division line of a road; a road boundary detector configured to detect a road boundary of the road; and a controller configured to execute first lane departure suppression control to suppress the departure of the vehicle from the division line and second lane departure suppression control to suppress the departure of the vehicle from the road boundary, wherein the controller executes the first lane departure suppression control in accordance with a distance in a lateral direction from the vehicle to a predetermined position based on the division line, and executes the second lane departure suppression control based on a time until the vehicle arrives at a predetermined position based on the road boundary.

### BRIEF DESCRIPTION OF THE DRAWINGS

The accompanying drawings, which are incorporated in and constitute a part of the specification, illustrate embodiments of the invention and, together with the description, serve to explain the invention.

FIG. 1 is a block diagram of a vehicle control apparatus according to an embodiment;

FIG. 2 is an explanatory view of the positional relationship between division lines, road boundaries, and a vehicle according to the embodiment;

FIG. 3 is an enlarged view of the periphery of the vehicle, the division line, and the road boundary; and

FIG. 4 is a flowchart showing the procedure of processing executed by the vehicle control apparatus according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

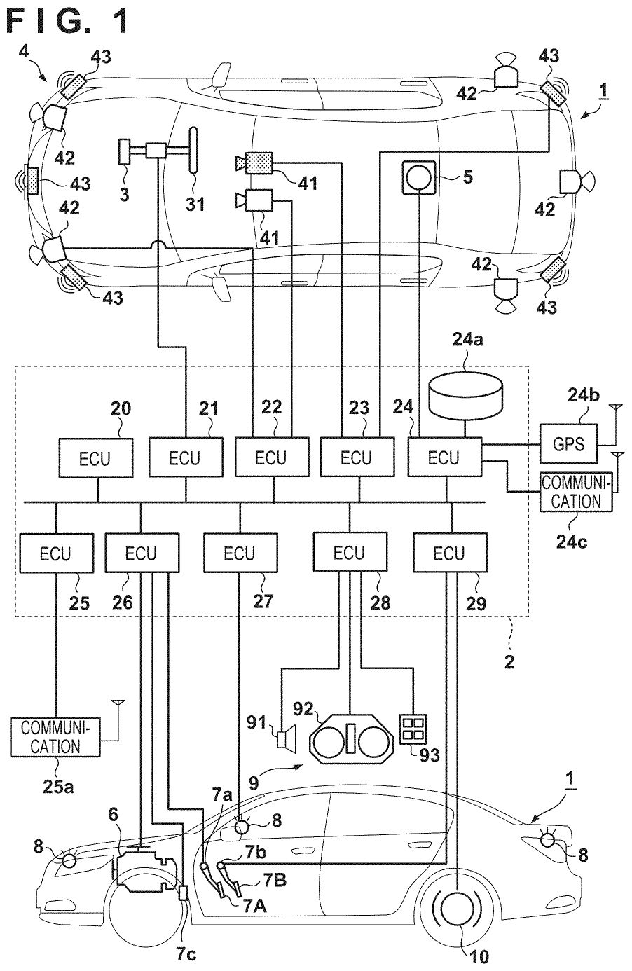

FIG. 1 is a block diagram of a vehicle control apparatus according to an embodiment of the present invention and controls a vehicle 1. FIG. 1 shows the outline of the vehicle 1 by a plan view and a side view. The vehicle 1 is, for example, a sedan-type four-wheeled vehicle.

A procedure of processing performed by an ECU 20 according to this embodiment shown in FIG. 1 will be described. The vehicle control apparatus includes a control unit (controller) 2. The control unit 2 includes a plurality of ECUs 20 to 29 communicably connected by an in-vehicle network. Each ECU includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed in the vehicle 1, and they can be subdivided or integrated as compared to this embodiment.

The ECU 20 executes control associated with automated driving of the vehicle 1. In automated driving, at least one of steering and acceleration/deceleration of the vehicle 1 is automatically controlled. The ECU 20 can also execute control related to driving support of the vehicle 1. Driving support includes, for example, adaptive cruise control (ACC) for reducing the driving load of a driver by executing travel by following a preceding vehicle by maintaining an appropriate following distance, and lane departure suppression control for suppress departure from a lane (division line). Automatic control of acceleration/deceleration is mainly performed in adaptive cruise control (ACC), and automatic control of the steering operation is mainly performed in lane departure suppression control.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving or driving support, the ECU 21 automatically controls the electric power steering device 3 in correspondence with an instruction from the ECU 20 and controls the direction of travel of the vehicle 1.

The ECUs 22 and 23 perform control of detection units (detector) 41 to 43 that detect the peripheral state of the vehicle and information processing of detection results. Each detection unit 41 is a camera (to be sometimes referred to as the camera 41 hereinafter) that captures the front side of the vehicle 1. In this embodiment, the cameras 41 are attached to the windshield inside the vehicle cabin at the roof front of the vehicle 1. When images captured by the cameras 41 are analyzed, the contour of a target or a division line (a white line or the like) of a lane on a road can be extracted.

The detection unit 42 is Light Detection and Ranging (LIDAR) (to be sometimes referred to as the LIDAR 42 hereinafter), and detects a target around the vehicle 1 or measures the distance to a target. In this embodiment, five LIDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each LIDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LIDARs, and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a route from the current position to the destination.

The ECU 25 includes a communication device 25a for inter-vehicle communication. The communication device 25a performs wireless communication with another vehicle on the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving or driving support, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8 (turn signals). In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in front of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified.

An input device 93 is a switch group that is arranged at a position where the driver can perform an operation, is used to issue an instruction to the vehicle 1, and may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving or driving support, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

<Control Examples>

Control of the vehicle 1 executed by the ECU 20 will be described next. The ECU 20 obtains, from the ECUs 22 and 23, information related to the peripheral state (for example, the division lines of the road, the road boundaries, oncoming vehicles, targets, and the like) of the vehicle 1, and issues instructions to the ECUs 21, 26, and 29 based on the obtained information to control the steering and deceleration/acceleration of the vehicle 1. For example, the ECU 20 executes lane departure suppression control to suppress the vehicle 1 from departing from a division line or a road boundary.

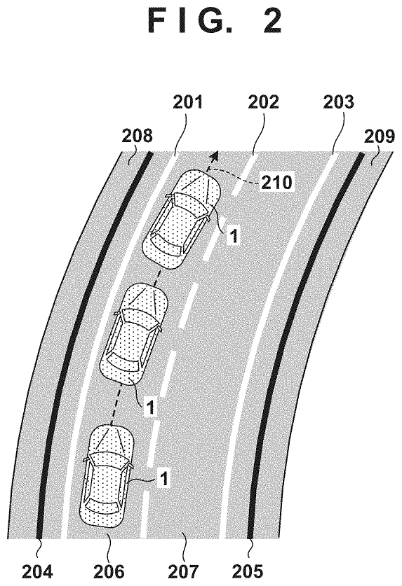

FIG. 2 is an explanatory view of lane departure suppression control of the vehicle 1 according to the embodiment. Reference numeral 201 denotes a first division line; 202, a second division line (center line); and 203, a third division line. Reference numerals 204 and 205 denote road boundaries. The road boundaries 204 and 205 may be formed by three-dimensional objects (for example, guardrails or curbstones) present above a position higher than a road. Alternatively, they may not always be three-dimensional objects, but may be boundaries at the same height as that of the road. Reference numeral 206 denotes a travel lane of the vehicle 1 defined by the first division line 201 and the second division line 202. Reference numeral 207 denotes a travel lane (oncoming lane), of a vehicle 200, defined by the second division line 202 and the third division line 203. Reference numerals 208 and 209 each denote a sidewalk.

In the example of FIG. 2, the vehicle 1 is traveling, along an arrow 210, in a state in which lane departure suppression control for suppressing the departure of the self-vehicle from the first division line 201 to the side of the road boundary 204 has been executed. In this embodiment, the self-vehicle will travel by executing first lane departure suppression control with respect to the first division line 201 and second lane departure suppression control with respect to the road boundary 204.

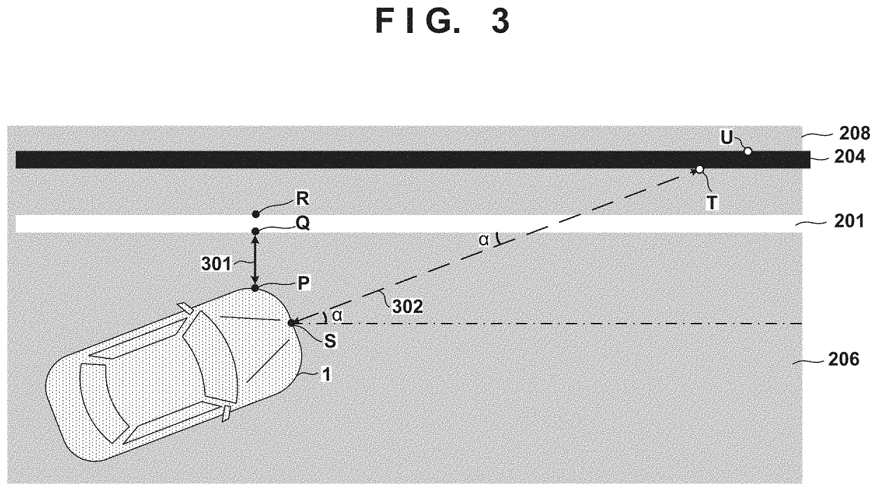

FIG. 3 is an enlarged view of the periphery of the vehicle 1, the first division line 201, and the road boundary 204. Reference numeral 301 denotes a distance from the first division line 201 (a point Q) from the vehicle 1 (a point P). Note that the position of the first division line 201 is not limited to the position of the point Q, which is at a boundary position between the first division line 201 and the first travel lane 206, and may be a predetermined position based on the first division line 201. For example, the position of the first division line 201 may be at the position of a point R which is at the boundary position between the side strip of the road and the first division line 201 or may be at an arbitrary position between the first division line 201 and the side strip of the road. Furthermore, the position of the first division line 201 may be set at a position shifted more to the side of the side strip of the road than the point R. Note that the position of the point P which indicates the position of the vehicle 1 is not limited to that exemplified in FIG. 3. The point P may be set at another location of the vehicle 1 or set at a position away from the vehicle 1 by a predetermined distance.

Reference numeral 302 denotes a distance from the vehicle 1 (a point S) to an intersection point T between the center line of the vehicle 1 and the road boundary 204. Note that the position of the road boundary 204 is not limited to the position of the point T, which is at a boundary position between the side strip of the road and the road boundary 204, and may be a predetermined position based on the road boundary 204. For example, the position of the road boundary 204 may be at the position of a point U which is at the boundary position between the road boundary 204 and the sidewalk 208 or may be at an arbitrary position between the road boundary 204 and the sidewalk 208. Furthermore, the position of the road boundary 204 may be set at a position shifted more to the side of the side strip of the road than the point T. Note that the position of the point S which indicates the position of the vehicle 1 is not limited to that exemplified in FIG. 3. The point S may be set at another location of the vehicle 1 or set at a position away from the vehicle 1 by a predetermined distance.

The ECU 20 executes the first lane departure suppression control with respect to the first division line 201 in accordance with a distance in the lateral direction from the vehicle 1 (for example, the point P) to a predetermined position (for example, the point Q, the point R, or the like) based on the first division line 201. For example, the first lane departure suppression control with respect to the first division line 201 is executed in a case in which the distance in the lateral direction is equal to or less than a threshold.

The ECU 20 executes the second lane departure suppression control with respect to the road boundary 204 in accordance with the time until the vehicle 1 (for example, the point S) arrives at a predetermined position (for example, the point T, the point U, or the like) based on the road boundary 204. The time until the arrival can be calculated based on a direction angle α of the vehicle 1, the distance 302, and the speed (vehicle speed) of the vehicle 1. The direction angle α indicates the direction of the vehicle 1 with respect to the travel lane as a reference. A more highly accurate processing operation can be performed in the second lane departure suppression control since the vehicle speed and the direction angle of the vehicle 1 are considered. Since the outer side of the first division line 201 is also paved, departure from this division line is permitted, to some extent, to prioritize the prevention of an excessive operation. However, since the road boundary 204 is further on the outer side than the division line and may be formed by a guardrail or a curbstone in some cases, departure with respect to the road boundary needs to be suppressed more. Hence, control based on the arrival time, which has higher accuracy, will be performed with respect to the road boundary 204, and control based on the distance in the lateral direction, which has high processing speed, will be performed with respect to the division line.

<Processing>

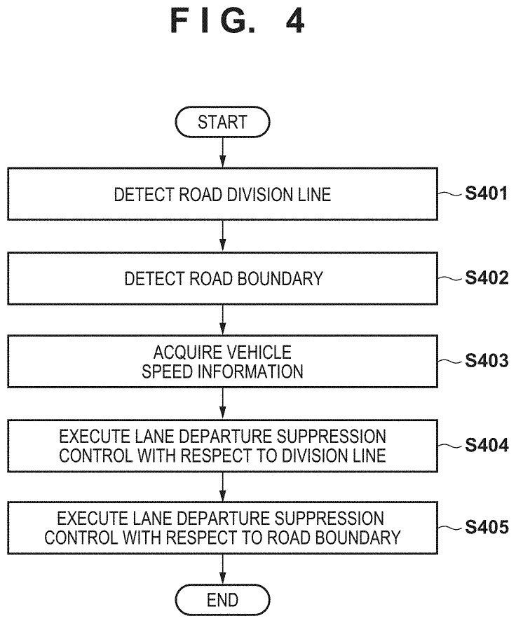

The procedure of processing executed by the vehicle control apparatus will be described next with reference to the flowchart of FIG. 4.

In step S401, the ECU 20 detects the division line of the road based on the information related to the peripheral state of the vehicle 1 obtained from the ECUs 22 and 23. In step S402, the ECU 20 detects the boundary of the road based on the information related to the peripheral state of the vehicle 1 obtained from the ECUs 22 and 23. In step S403, the ECU 20 obtains, from the ECU 26, the vehicle speed information of the vehicle 1 detected by the vehicle speed sensor 7c.

In step S404, the ECU 20 executes the lane departure suppression control to suppress the departure of the self-vehicle from the detected division line. More specifically, the ECU 20 executes the first lane departure suppression control with respect to the first division line 201 in accordance with the distance (for example, the distance 301 of FIG. 3) in the lateral direction from the vehicle 1 to a predetermined position (for example, the point Q, the point R, or the like of FIG. 3) based on the first division line 201. For example, it may be set so that the first lane departure suppression control will be executed in a case in which the distance in the lateral direction is equal to or less than a threshold.

In step S405, the ECU 20 determines the execution timing of the lane departure suppression control to suppress the departure of the self-vehicle from the detected road boundary. More specifically, the ECU 20 executes the second lane departure suppression control with respect to the road boundary 204 in accordance with the time until the vehicle 1 arrives at a predetermined position (for example, the point T or the point U of FIG. 3) based on the road boundary 204. In this case, the ECU 20 calculates the direction angle (the direction of the vehicle 1 with respect to the travel lane as a reference, for example, the direction angle α of FIG. 3) of the vehicle 1 based on the information related to the peripheral state of the vehicle 1 obtained from the ECUs 22 and 23, and calculates the distance between the road boundary 204 and a line along the direction angle. Subsequently, the time until the vehicle 1 arrives at the predetermined position based on the road boundary 204 is calculated based on the speed information of the vehicle 1 obtained in step S403. For example, it will be set so that the second lane departure suppression control with respect to the road boundary 204 will be executed in a case in which the elapsed time has reached a threshold (a time shorter than the calculated time) based on the calculated time. The series of processes of FIG. 4 has been described above.

As described above, in this embodiment, control based on the distance in the lateral direction is performed in the lane departure suppression control with respect to the division line, and control based on the arrival time will be performed based on the lane departure suppression control with respect to the road boundary. As a result, since the lane departure suppression control, with respect to the division line, is performed based on the distance in the lateral direction without considering the vehicle speed or the direction of the vehicle with respect to the division line, excessive operation of the lane departure suppression control can be prevented. In addition, since lane departure suppression control, with respect to the road boundary, is performed based on the predicted time until the departure by considering the vehicle speed and the direction of the vehicle with respect to the road boundary, departure prevention can be performed with higher accuracy. Therefore, appropriate vehicle control with respect to each of the road boundary and the division line can be implemented.

[Modification]

Note that the above embodiment has described an example in which control based on the distance in the lateral direction is performed in the lane departure suppression control with respect to the division line, and control based on the arrival time is performed in the lane departure suppression control with respect to the road boundary. However, it may be set so that the control will be executed when a distance between the division line and the road boundary is equal to or more than a predetermined distance. The distance between the division line and the road boundary is, for example, a distance in the road width direction. Since this will allow control to be applied only in a case in which there is a wide margin after the self-vehicle has departed from the division line, it will be possible to perform appropriate control under a state in which there is some margin even if the self-vehicle has departed from the division line.

In addition, the control according to the above-described embodiment may be executed in a case in which the curvature of the road is equal to or less than a threshold. For example, since the detection accuracy of the road boundary and that of the division line increase as the straightness of the road increases, the margin of travel will also increase. Thus, it will be possible to perform appropriate control under a state of a large margin of travel. Also, it may be set so that the road will be determined to be a straight road in a case in which the curvature of the road is equal to or less than a threshold, and the control may be performed when the road is determined to be a straight road. Note that the ECU 20 can obtain the curvature of the road by calculating the shape of the road based on the information related to the peripheral state of the vehicle 1 obtained from the ECUs 22 and 23 or based on the information of the detected division line or the detected road boundary.

Furthermore, it may be set so that a lane width may be calculated based on the detected division line, and the control according to the above-described embodiment may be executed in a case in which the lane width is equal to or more than a predetermined value. If the lane width is wide to some extent, the margin of travel will increase, and appropriate control can perform under a state of a large margin of travel.

According to the present invention, appropriate vehicle control with respect to each of the road boundary and the division line can be implemented.

### Other Embodiments

A program for implementing each function of one or more driving support apparatuses described in the embodiments is supplied to a system or apparatus via a network or storage medium, and one or more processors in the computer of the system or apparatus can read out and execute the program. This form can also implement the present invention.

### Summary of Embodiment

1. A vehicle control apparatus according to the above-described embodiment is a vehicle control apparatus that controls a vehicle (for example, 1), comprising:

a division line detector (for example, 20, 22, 23, 41, 42, 43) configured to detect a division line (for example, 201) of a road;

a road boundary detector (for example, 20, 22, 23, 41, 42, 43) configured to detect a road boundary (for example, 204) of the road; and

a controller (for example, 20) configured to execute first lane departure suppression control to suppress the departure of the vehicle from the division line and second lane departure suppression control to suppress the departure of the vehicle from the road boundary,

wherein the controller executes the first lane departure suppression control in accordance with a distance (for example, 301) in a lateral direction from the vehicle to a predetermined position (for example, Q, R) based on the division line, and executes the second lane departure suppression control based on a time until the vehicle arrives at a predetermined position (for example, T, U) based on the road boundary.

According to this embodiment, appropriate vehicle control with respect to each of the road boundary and the division line can be implemented.

2. In the vehicle control apparatus according to the above-described embodiment, the controller executes the first lane departure suppression control and the second lane departure suppression control in a case in which a distance between the division line and the road boundary is not less than a predetermined distance.

According to this embodiment, since control is applied only in a case in which there is a wide margin after the self-vehicle has departed from the division line, appropriate control can be performed with some margin even if the self-vehicle has departed from the division line.

3. The vehicle control apparatus according to the above-described embodiment, further comprising:

a shape detector (for example, 20, 22, 23, 41, 42, 43) configured to detect a shape of the road,

wherein the controller executes the first lane departure suppression control and the second lane departure suppression control in a case in which a curvature of the road is not more than a threshold.

According to this embodiment, since the detection accuracy of the road boundary and that of the division line increases as the straightness of the road increases, the margin of travel increases, and appropriate control can be performed under a state of a large margin of travel.

4. In the vehicle control apparatus according to the above-described embodiment, the controller executes the first lane departure suppression control and the second lane departure suppression control in a case in which the road is a straight road.

According to this embodiment, appropriate control can be performed under a state in which the detection accuracy of the road boundary and the division line is high.

5. In the vehicle control apparatus according to the above-described embodiment, the controller calculates a lane width based on the division line detected by the division line detector, and executes the first lane departure suppression control and the second lane departure suppression control in a case in which the lane width is not less than a predetermined value.

According to this embodiment, appropriate control can be performed under a state in which the lane width is wide to some extent and the margin of travel is large.

6. In the vehicle control apparatus according to the above-described embodiment, the controller calculates, based on a speed of the vehicle, a direction angle of the vehicle, and a distance between a line along the direction angle and the predetermined position based on the road boundary, the time until the vehicle arrives at the predetermined position.

According to this embodiment, the time until the vehicle arrives at the road boundary can be calculated highly accurately.

7. A vehicle (for example, 1) according to the above-described embodiment is a vehicle comprising a vehicle control apparatus according to the above-described embodiment.

According to this embodiment, the processing executed by the vehicle control apparatus can be implemented in a vehicle.

8. An operation method of a vehicle control apparatus according to the above-described embodiment is an operation method of a vehicle control apparatus that controls a vehicle (for example, 1), the method comprising:

detecting (for example, S401) a division line (for example, 201) of a road;

detecting (for example, S402) a road boundary (for example, 204) of the road; and

executing (for example, S404, S405) first lane departure suppression control to suppress the departure of the vehicle from the division line and second lane departure suppression control to suppress the departure of the vehicle from the road boundary,

wherein in the executing, the first lane departure suppression control is executed in accordance with a distance (for example, 301) in a lateral direction from the vehicle to a predetermined position (for example, Q, R) based on the division line, and the second lane departure suppression control is executed based on a time until the vehicle arrives at a predetermined position (for example, T, U) based on the road boundary.

According to this embodiment, appropriate vehicle control with respect to each of the road boundary and the division line can be implemented.

9. A program according to the above-described embodiment is a program for causing a computer to function as a vehicle control apparatus according to the above-described embodiment.

According to this embodiment, the contents of the present invention can be implemented by a computer.

The invention is not limited to the foregoing embodiments, and various variations/changes are possible within the spirit of the invention.

What is claimed is:

1. A vehicle control apparatus that controls a vehicle, comprising:
a division line detector configured to detect a division line of a road;
a road boundary detector configured to detect a road boundary of the road; and
a controller configured to execute first lane departure suppression control to suppress the departure of the vehicle from the division line and second lane departure suppression control to suppress the departure of the vehicle from the road boundary,
wherein the controller executes the first lane departure suppression control in accordance with a distance in a lateral direction from the vehicle to a predetermined position based on the division line, and executes the second lane departure suppression control based on a time until the vehicle arrives at a predetermined position based on the road boundary.

2. The apparatus according to claim 1, wherein the controller executes the first lane departure suppression control and the second lane departure suppression control in a case in which a distance between the division line and the road boundary is not less than a predetermined distance.

3. The apparatus according to claim 1, further comprising:
a shape detector configured to detect a shape of the road,
wherein the controller executes the first lane departure suppression control and the second lane departure suppression control in a case in which a curvature of the road is not more than a threshold.

4. The apparatus according to claim 3, wherein the controller executes the first lane departure suppression control and the second lane departure suppression control in a case in which the road is a straight road.

5. The apparatus according to claim 1, wherein the controller calculates a lane width based on the division line detected by the division line detector, and executes the first lane departure suppression control and the second lane departure suppression control in a case in which the lane width is not less than a predetermined value.

6. The apparatus according to claim 1, wherein the controller calculates, based on a speed of the vehicle, a direction angle of the vehicle, and a distance between a line along the direction angle and the predetermined position based on the road boundary, the time until the vehicle arrives at the predetermined position.

7. A vehicle comprising a vehicle control apparatus defined in claim 1.

8. An operation method of a vehicle control apparatus that controls a vehicle, the method comprising:
detecting a division line of a road;
detecting a road boundary of the road; and
executing first lane departure suppression control to suppress the departure of the vehicle from the division line and second lane departure suppression control to suppress the departure of the vehicle from the road boundary,
wherein in the executing, the first lane departure suppression control is executed in accordance with a distance in a lateral direction from the vehicle to a predetermined position based on the division line, and the second lane departure suppression control is executed based on a time until the vehicle arrives at a predetermined position based on the road boundary.

9. A non-transitory computer-readable storage medium storing a program for causing a computer to execute an operation method of a vehicle control apparatus that controls a vehicle, the method comprising:
detecting a division line of a road;
detecting a road boundary of the road; and
executing first lane departure suppression control to suppress the departure of the vehicle from the division line and second lane departure suppression control to suppress the departure of the vehicle from the road boundary,
wherein in the executing, the first lane departure suppression control is executed in accordance with a distance in a lateral direction from the vehicle to a predetermined position based on the division line, and the second lane departure suppression control is executed based on a time until the vehicle arrives at a predetermined position based on the road boundary.
